(19) United States
(12) Patent Application Publication
(10) Pub. No.: US 2002/0130287 A1
(43) Pub. Date: Sep. 19, 2002

(54) Noise-suppressive valve assembly and method for use

(76) Inventors: Craig D. Smith, Penfield, NY (US); Anthony T. Tocco, LeRoy, NY (US); Kenneth J Dauer, Livonia, NY (US)

Correspondence Address: Delphi Technologies, Inc., Mail Code 480414420, P.O. Box 5052, Troy, MI, 48007, US

(21) Appl. No.: 09/810,987

(22) Filed: Mar. 16, 2001

(51) Int. Cl. F16K 31/02

(52) U.S. Cl. 251/129.15

(57) ABSTRACT

A short-stroke solenoid-actuated valve assembly modified to minimize mechanical clatter. The valve has a valve seat formed of compressed powdered metal to reduce the intensity and sharpness of sound resulting from closing contact with the valve head. The solenoid pole pieces are formed of powdered metal to reduce weight, reduce noise, and improve response of the actuator. The solenoid armature is de-coupled from the valve pintle shaft to decrease impact loading upon opening and closing of the valve. When the valve is employed in a vehicle powered by an internal combustion engine, the solenoid may be actuated at a multiple of the engine's frequency of revolutions, the timing of actuation being selected to occur during a portion of the engine's cycle when the engine is otherwise emitting a high volume of noise. Thus, the actuation sounds of the solenoid and valve may be masked.

### TECHNICAL FIELD

The present invention is related to solenoid-actuated poppet valves; more particularly, to such poppet valves used to meter the recirculation of exhaust gas (EGR) into the fuel/air intake systems of internal combustion engines; and most particularly, to an EGR valve wherein the noise output from valve actuation is mechanically damped through improved valve construction and improved materials and is systematically masked behind existing noise peaks in an engine's normal firing cycle.

### BACKGROUND OF THE INVENTION

In many automotive vehicles, a variety of “underhood” systems include solenoid operated valves, typically poppet-type valves wherein a pintle-mounted valve head (the poppet) is variably mated with a concentric valve seat separating two chambers to regulate flow of material across the valve seat between the chambers. Systems using such valves include, for example, canister purge systems, vacuum actuators, EGR valves, carburetor mixture systems, and braking systems. In many vehicles currently being manufactured, variable control of these devices is achieved digitally by software in a master engine control module (ECM). In digital control, the valve may be stroked between fully closed and fully opened, the duty cycle being varied to achieve a desired average flow, rather than by driving the valve head to an intermediate position and holding it there, as in prior art analog control systems. Thus the length of stroke of the valve is fixed by its construction and is not an operational variable. For actuation, the valve typically is provided with a train of pulses at a constant frequency, for example, 10 Hz or 20 Hz, and the pulse-width of the open phase versus the closed phase is modulated to achieve the desired flow. This may be changed at the discretion of the calibrator. Digitally-controllable valves typically have very short strokes, on the order of 350 μm, and rely on relatively large-diameter flow passages to achieve flow comparable to that achievable by known long-stroke analog-controlled valves. A short-stroke valve suitable for modification in accordance with the invention is disclosed in U.S. Pat. No. 6,189,519 B1 issued Feb. 20, 2001 to Press et al., the relevant disclosure of which is herein incorporated by reference.

A recurring problem is using full-stroke actuation is audible noise emanating from the valve and attached solenoid. The valve can emit a sharp sound at various points in its cycle, such as when the head strikes the seat, and when the pintle and solenoid armature strike the valve or solenoid housing at either end of the solenoid stroke. The sound signature that these devices generate is often audible, and at certain engine conditions is objectionable, especially at idle. In many cases, it is necessary to resort to sound suppressive measures such as absorptive mountings and insulation, which can be costly, consumptive of precious space in a vehicle, and only partially effective.

Another problem is accelerated wear of moving components in such solenoid-actuated valves resulting from high impact loads and thermally-induced misalignments.

What is needed is a an arrangement of valve and solenoid components and a selection of materials for valve construction which minimizes the mechanical noise of operation of a solenoid-actuated valve and reduces the mechanical loads imposed on various components, as well as a method of hiding remaining noise from the valve behind the noise profile of a vehicle's engine.

### SUMMARY OF THE INVENTION

Briefly described, a short-stroke solenoid-actuated valve is modified to minimize mechanical clatter. The valve has a valve seat formed of compressed powdered metal to reduce the intensity and sharpness of sound resulting from closing contact with the valve head. Preferably, the solenoid inner pole piece is also formed of powdered metal to minimize clatter at the actuation extremes of the solenoid armature, and the outer pole piece is also formed of powdered metal to reduce weight and to speed response of the actuator. Preferably, the solenoid armature is de-coupled from the valve pintle shaft to decrease impact loading upon opening and closing of the valve. When the valve is employed in a vehicle powered by an internal combustion engine, the solenoid preferably is pulsed at some multiple of the engine's frequency of revolutions. The timing of such pulsation is selected to occur during a portion of the engine's cycle when the engine is otherwise emitting a high volume of noise, thus masking the actuation sounds of the solenoid and valve.

### BRIEF DESCRIPTION OF THE DRAWINGS

These and other features and advantages of the invention will be more fully understood and appreciated from the following description of certain exemplary embodiments of the invention taken together with the accompanying drawings, in which:

FIG. 1 is an elevational cross-sectional view of a prior art short-stroke solenoid-actuated valve for modulated pulse-width control of flow;

FIG. 2 is an elevational cross-sectional view of a short-stroke solenoid-actuated valve as modified in accordance with the invention;

FIG. 3 is a graph showing a solenoid device such as the valve shown in FIG. 2 being actuated systematically to coincide at a 1:1 ratio with a signal sensed from rotation of an engine's camshaft;

FIG. 4 is a graph like that shown in FIG. 3, showing the solenoid device re-ranged to coincide with every second rotation of an engine's camshaft; and

FIG. 5 is a graph of solenoid frequency as a function of engine frequency, showing re-ranging of the solenoid device to progressively lower ratios, thereby extending the range of the solenoid device over a large range of engine speeds.

### DESCRIPTION OF THE PREFERRED EMBODIMENTS

Benefits and advantages of a solenoid-actuated valve in accordance with the invention may be better appreciated by first considering a prior art valve.

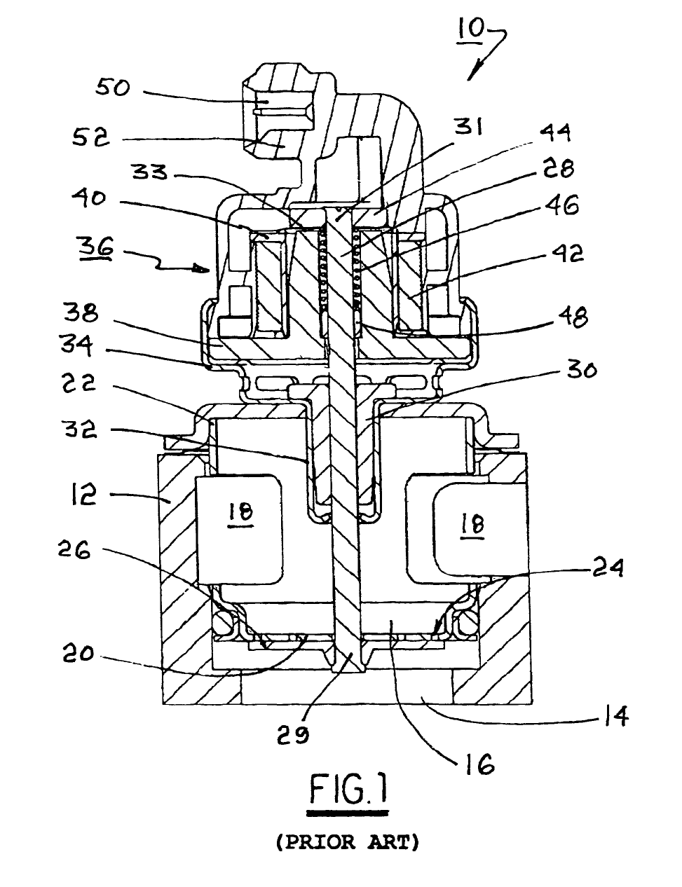

Referring to FIG. 1, a prior art short-stroke solenoid-actuated valve assembly 10 includes a valve body 12 having a first port 14 separated from an internal chamber 16 and associated flow passage 18 by a valve seat 20 formed integrally with a valve base 22 insertable into body 12. Seat 20 is typically a perforated plate having orifices 24 which are covered and uncovered to vary flow therethrough by a valve plate 26 attached to and actuated axially by a valve pintle shaft 28 at a distal end 29 thereof. Shaft 28 is disposed in an axial bore in shaft bushing 30 which is supported in a well 32 formed in actuator housing 34.

Actuator assembly 36 includes housing 34, primary pole piece 38, secondary pole piece 40, electric coil 42, armature 44, shaft return spring 46, shaft seal 48, connector 50, and encapsulating shroud 52. The pole pieces typically are formed of iron or steel, and the valve body, base, seat, plate, and shaft are formed of steel or other materials suitable to the end use of the valve.

Armature 44 is connected to the proximal end 31 of shaft 28 such that the armature, shaft, and valve plate are oscillatable axially as an integral unit by actuator assembly 36. The stroke of the valve is defined by the gap 33 between armature 44 in the valve-closed position, shown in FIG. 1, and the upper end of primary pole piece 38.

The details of construction and operation of assembly 10 are substantially as disclosed in the incorporated reference.

Significant clatter occurs in the actuation of valve assembly 10. The kinetic energy contained in the integral plate, shaft, and armature is applied to the primary pole piece 38 as a stroke-limiting dead stop for valve opening, and to valve seat 20 upon closing. Actuations may occur at relatively high frequency, typically, 20 Hz, since the objective of on-off control is a time-average flow. Several of the components of the prior art assembly are highly conducive of sound and may also be prone to ringing, which can add significantly to an undesirable actuation noise level.

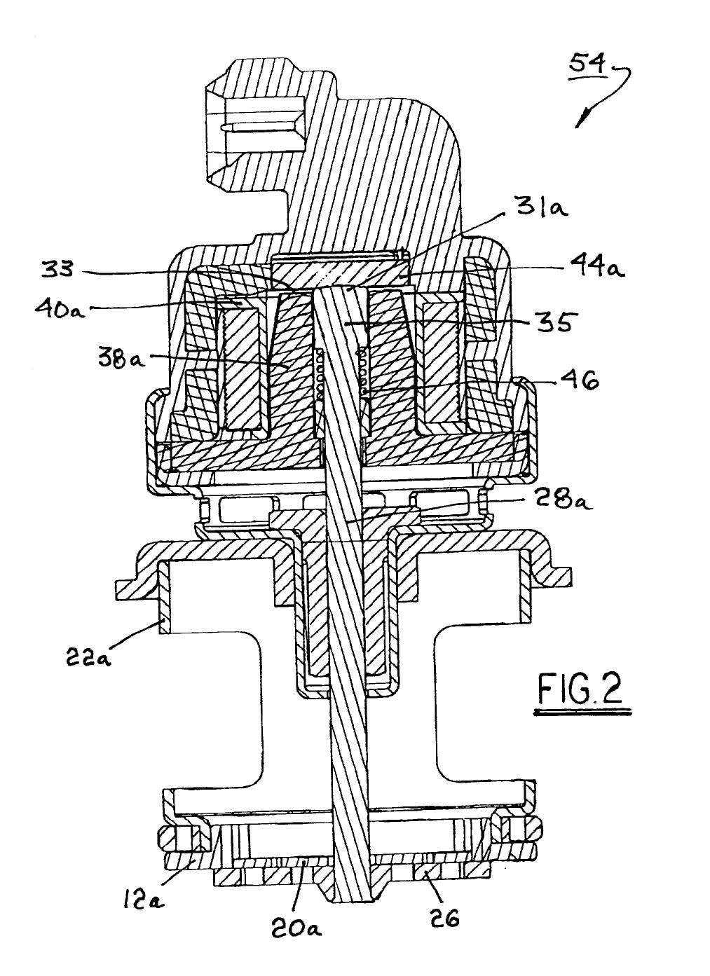

Referring to FIG. 2, an improved short-stroke solenoid-actuated valve assembly 54 is formed in most respects identically with prior art assembly 10. However, significant reduction in mechanical clatter and assembly performance are achieved through the following novel improvements, involving the use of acoustic damping materials in forming the assembly, restructuring of the actuating components, and the masking of residual actuation sound behind existing engine noise.

First, improved valve seat 20a preferably is formed separately from valve base 22a and is disposed in valve body 12a. Alternatively, seat 20a and base 22a can be provided as an integral unit as in the prior art. Seat 20a is formed of a suitable acoustically dead material, preferably compressed powdered metal. The forming of metal parts by compressing powdered metals is well known in the forming arts. If desired, an integral base/seat unit similar to the prior art unit may be formed entirely of powdered metal. Preferably, the surface of seat 20a for making contact with valve plate 26 is locally densified as by surface smearing, qualifying, coining, or other known techniques to increase its durability. Forming seat 20a from powdered metal significantly reduces the generation and transmission of sound resulting from the impact of the valve plate on the valve seat.

Second, improved primary pole piece 38a preferably is formed from powdered metal, thereby reducing clatter from impact of the armature at the end of the valve-opening stroke, reducing mass of the component and therefore mass of the assembly as described in detail below, and improving magnetic characteristics of the pole piece, also as described below.

Preferably, improved secondary pole piece 40a is also formed of powdered metal.

Third, improved pintle shaft 28a is provided with a flared head 35 at proximal end 31a for capturing return spring 46 which, when compressed by the valve being opened, thus acts directly upon the pintle shaft rather than upon the armature, as in prior art assembly 10, to close the valve upon de-energizing of the solenoid. Further, armature 44a is not connected to shaft 28a but acts on it only in compression. As shown in FIG. 2 in the valve-closed position, shaft end 31a extends beyond the end of primary pole piece 38a and across gap 33 to make contact with armature 44a. When the solenoid is energized to open the valve, only the kinetic energy of the armature is brought to bear on the upper end of pole piece 38a, thus reducing the impact and clatter over that produced by the prior art solenoid. The pintle shaft 28a and valve plate 26 are cast loose from the armature and are carried by their momentum through a short, predetermined distance of over-travel of the mechanically configured open position, before beginning the closing return stroke under impetus from compressed spring 46. Further, when the valve re-closes, only the kinetic energy of the pintle shaft and valve plate are brought to bear on the valve seat, thus reducing the impact over that experienced by the prior art valve.

Powdered metal used in forming the just-described components is preferably a 400-series stainless steel, most preferably 410 L. These materials saturate at lower flux levels than iron and can increase the actuation force of the solenoid from, typically, about 15 N in prior art solenoids to about 75 M in same-size solenoids formed in accordance with the present invention, thus permitting if desired a substantial reduction in size of the solenoid. In addition, prior art iron pole pieces typically have a density of about 7.8 g/cm³, whereas the present pole pieces preferably have a density of about 6.0 g/cm³, thus affording a significant reduction in overall weight of the valve assembly. It will be obvious that further weight reductions may be achieved by forming other assembly components, for example, valve body 12a, from powdered metal.

Fourth, in use, the valve assembly preferably is operated by an improved method in accordance with the invention as follows. In many applications for which improved valve assembly 54 is suitable, for example, as an exhaust gas recirculation valve for an internal combustion engine, an associated device such as the engine has a characteristic sound output signature. In the case of an engine, the signature is repetitive with each full engine cycle which, for a four-stroke engine, corresponds to one full revolution of a camshaft. The sound output of an engine is not equal in frequency distribution or amplitude throughout the engine cycle but rather has distinct amplitude peaks. Because the appreciation of changes in loudness by the human ear is logarithmic, giving rise to the decibel scale, superimposing two sounds of, for example, equal sound energy will not result in a single sound apparently twice as loud as either of the contributors. This phenomenon permits masking of one sound by another. Surprisingly, in the present invention, the sound of valve actuation may be masked or hidden behind an already high-amplitude peak in an engine's sound cycle.

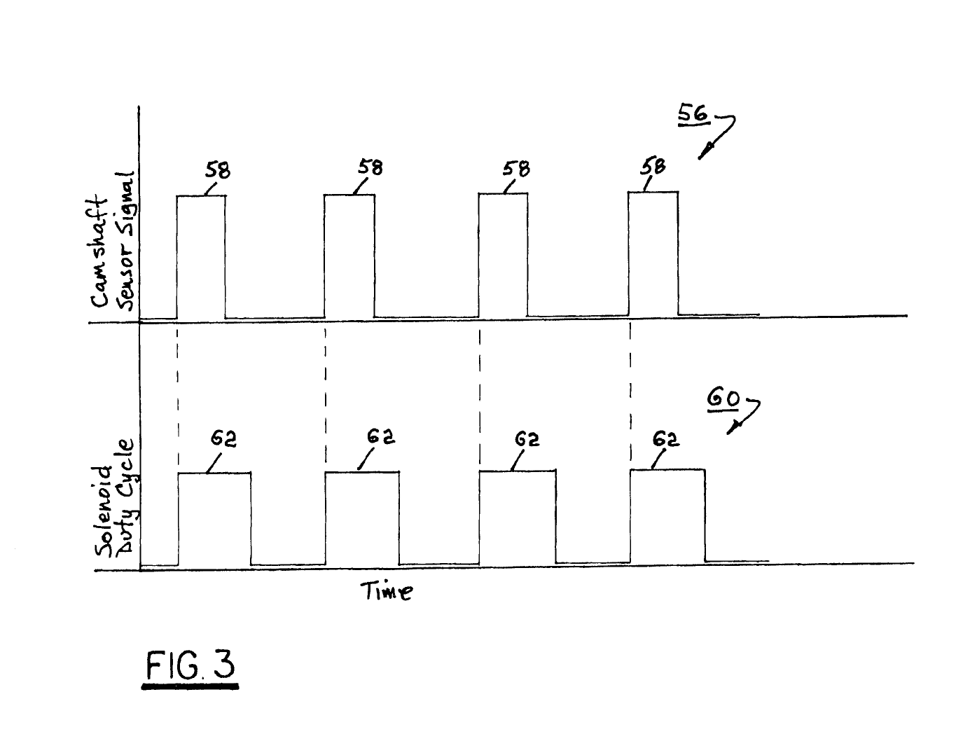

The sound cycle of an engine is analyzed, and a particular sound peak is identified and related to a rotational position of an engine crankshaft, or preferably, camshaft. A camshaft rotation sensor is positioned or programmed in known fashion to provide a signal at the selected rotational position. Such a signal is conveniently shown as a square wave 56 in FIG. 3 comprising cyclically repeating peaks 58. As disclosed and described in the incorporated reference, the actuation of a short-stroke EGR valve may be controlled by a computer-based engine control module (ECM). As is well known to those skilled in the art, such a module may be programmed to provide an output response to an input signal. In the present invention, the ECM is programmed to vary and align the solenoid duty cycle 60 to the camshaft cycle 56, causing the solenoid actuation noise to be masked by the engine noise through most of each solenoid actuation cycle 62.

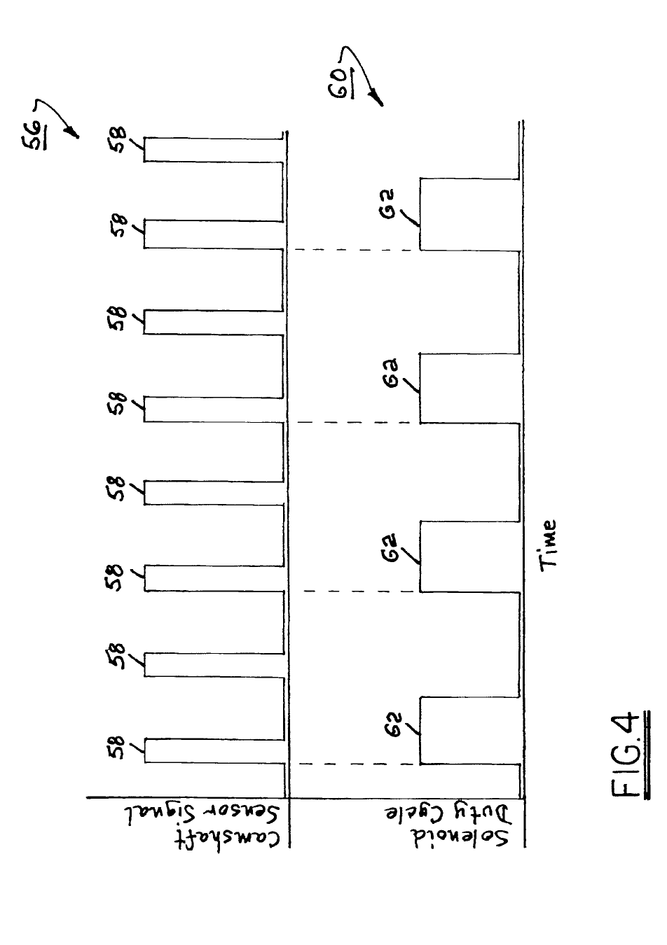

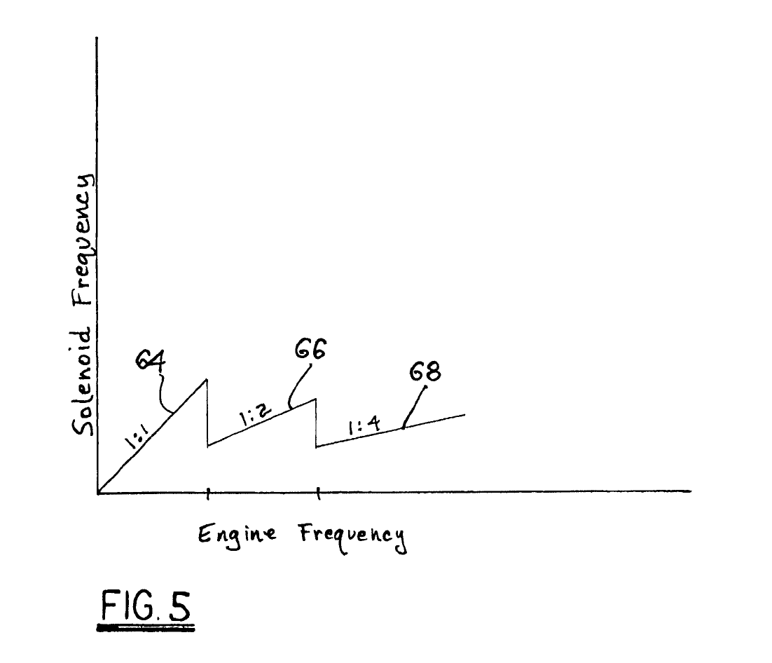

The inherent dynamic response range of the solenoid actuator typically is substantially less than the dynamic range of an internal combustion engine. Referring to FIGS. 4 and 5, it is seen that the dynamic range of the solenoid may be re-ranged to accommodate the overall engine range by changing the response ratio of solenoid actuations to engine cycles from 1:1 64 to progressively lower ratios such as 1:2 66 and 1:4 68. Such re-ranging is readily achieved by software programming of the ECM as is well known in the art. In each range, the onset of each solenoid actuation still coincides with the onset of predetermined high-amplitude peak in engine noise and is thus at least partially masked behind it.

In applications utilizing a plurality of solenoids, the actuation of each solenoid may be hidden behind the same or different peaks in engine sound output, in accordance with the invention.

It will be apparent to one of ordinary skill in the art that a noise-suppressive valve and method for use, as illustrated and described herein, and many of its features, could take various forms as applied to other applications and the like. While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A solenoid-actuated poppet valve having a pintle shaft and having at least one pole piece in said solenoid formed of powdered metal.

2. A valve in accordance with claim 1 wherein first and second pole pieces in said solenoid are formed of powdered metal.

3. A valve in accordance with claim 1 further comprising a valve seat formed of powdered metal.

4. A valve in accordance with claim 1 further comprising a valve body formed of powdered metal.

5. A valve in accordance with claim 1 wherein said powdered metal is a 400-series stainless steel.

6. A valve in accordance with claim 1 wherein an armature of said solenoid is de-coupled from said pintle shaft.

7. A method for masking noise generated by a solenoid-actuated valve disposed for use in proximity to a cyclic noise generator, comprising the steps of:
a) determining the amplitude profile and repeating frequency of sound generated by said noise generator;
b) selecting a high-amplitude portion of said profile; and
c) actuating said valve during said high-amplitude portion at a predetermined multiple of said repeating frequency to conceal said valve noise behind said noise of said generator.

8. A method in accordance with claim 6 wherein said cyclic noise generator is an internal combustion engine.

9. A method in accordance with claim 7 wherein said valve and said engine are disposed in an automotive vehicle.

10. An internal combustion engine, comprising:
a) an exhaust manifold;
b) an intake manifold; and
c) an exhaust gas recirculation (EGR) valve assembly connected between said exhaust manifold and said intake manifold for controllably recirculating exhaust gas into said intake manifold, wherein said EGR valve assembly includes a solenoid-actuated poppet valve having at least one pole piece in said solenoid formed of powdered metal.

11. An engine in accordance with claim 10 wherein said assembly further includes a pintle shaft de-coupled from a solenoid armature.
